(19) United States
(12) Patent Application Publication
(10) Pub. No.: US 2024/0367872 A1
(43) Pub. Date: Nov. 7, 2024

(54) Product Measuring and Dispensing

(71) Applicant: Megan Fisher, Tampa, FL (US)

(72) Inventor: Megan Fisher, Tampa, FL (US)

(21) Appl. No.: 18/144,183

(22) Filed: May 6, 2023

(51) Int. Cl. B65D 47/26; B65D 47/06; B65D 83/06

(52) U.S. Cl. CPC B65D 47/263; B65D 47/068; B65D 83/06; B65D 2547/066

(57) ABSTRACT

Systems for measuring an ingredient are provided consisting of dispensing caps attached to ingredient containers configured to receive the ingredient in a known volume and dispense the known volume.

### TECHNICAL FIELD

The present disclosure relates generally to devices, systems, and methods for measuring and dispensing of products.

### BACKGROUND

Measuring of dry and liquid goods in a kitchen is often a frustrating event due to the need to locate not only the ingredients, but also the appropriate measuring devices. As anyone who has cooked knows, measuring cups, spoons, and similar are often not put where they belong, are dirty, or are simply of an inconvenient size to measure and dispense the ingredient.

### SUMMARY

In a first aspect, the disclosure provides a system for measuring an ingredient. A dispensing cap with a flexible silicone thread configured to screw onto a threaded bottle is provided. The dispensing cap has a first section of a known volume configured to receive the ingredient in the known volume from the threaded bottle when a user inverts the threaded bottle. The dispensing cap has a closure configured to prevent fluid communication between the section and the threaded bottle when the closure is engaged by the user. The dispensing cap has a dispenser configured to provide fluid communication between the section and an outside space when the dispenser is engaged by the user. The dispenser is further configured for a user to pour the ingredient out of the section into the outside space.

In a second aspect, the disclosure provides a system for measuring an ingredient. A cap with a flexible silicone thread configured to screw onto a threaded bottle, a shaft, and a slit is provided. A rotatable filling section is attached to the cap and configured to rotate to block the slit and prevent fluid communication between the threaded bottle and a dispensable volume or to expose the slit and allow fluid communication between the threaded bottle and the dispensable volume. A volume selector is inserted into the radial volume and rotatably attached to the shaft, wherein the volume selector rotates to be adjacent a first end of the portion of the radial space to provide a largest dispensable volume and the volume selector rotates to be adjacent a second end of the portion of the radial space to provide a smallest measurable volume. The dispensable volume is any volume between and including the largest dispensable volume and the smallest dispensable volume. A lid configured to cover the dispensable volume. A user rotates the rotatable filling section such that the threaded bottle is in fluid communication with the dispensable volume, the user further rotates the volume selector to a desired dispensable volume, and the user inverts the threaded bottle and cap such that the ingredient pours into the desired dispensable volume. The user rotates the rotatable filling section such that the threaded bottle and the dispensable volume are not in fluid communication and the user removes or rotates the lid to dispense the ingredient from the desired dispensable volume to an outside space.

In a third aspect, the disclosure provides a system for measuring an ingredient. A dispensing cap is configured to attach to an ingredient container. The dispensing cap has a first section of a known volume configured to receive the ingredient in the known volume from the threaded bottle. The dispensing cap has a closure configured to prevent fluid communication between the section and the ingredient container when the closure is engaged by the user. The dispensing cap has a dispenser configured to provide fluid communication between the section and an outside space when the dispenser is engaged by the user and the dispenser further configured for a user to pour the ingredient out of the section into the outside space.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1A is a front elevation view of a bottle and a cap with a rocker.

FIG. 1B is a cross-sectional view of the bottle and cap of FIG. 1A.

FIG. 1C is an isometric view of the bottle and cap of FIG. 1A.

FIG. 1D is a side elevation view of the bottle and cap of FIG. 1A.

FIG. 2A is a front left isometric view of a bottle and a cap with a rocker.

FIG. 2B is a back right isometric view of the bottle and cap of FIG. 2A with the dispenser cap removed.

FIG. 3A is a front left isometric view of a bottle and a cap with a rocker.

FIG. 3B is a cross-sectional view of the bottle and cap of FIG. 3A.

FIG. 4A is a back left cross-sectional view of a bottle and cap with a rocker.

FIG. 4B is a cross-sectional view of the bottle and cap of FIG. 5A.

FIG. 5A is a front elevation view of a bottle and cap with rocker where the cap and rocker are in exploded view.

FIG. 5B is a side elevation view of the bottle and cap of FIG. 6A.

FIG. 5C is a cross sectional view of the bottle and cap of FIG. 6A.

FIG. 6 is a front left isometric view of a box and cap with a rocker.

FIG. 7A is a front top isometric view of a bottle and cap.

FIG. 7B is a cross section of the bottle and cap of FIG. 7A.

FIG. 7C is an exploded front top isometric view of the bottle and cap of FIG. 7A.

FIG. 7D is an exploded front bottom isometric view of the bottle and cap of FIG. 7A.

FIG. 8A is an isometric view of a bottle and dispenser.

FIG. 8B is an elevation view of the bottle and dispenser of FIG. 8A.

FIG. 8C is an elevation view of the bottle and inside of the dispenser of FIG. 8A.

FIG. 9A is an isometric view of a bottle and dispenser.

FIG. 9B is a side view of the bottle and dispenser of FIG. 9A.

FIG. 9C is a top view of the bottle and dispenser of FIG. 9A.

FIG. 9D is a cross-sectional view of FIG. 9B.

FIG. 9E is a cross-sectional view of FIG. 9A.

FIG. 10A is an isometric view of a rocker with a spacer in a first position.

FIG. 10B is an isometric view of the rocker of FIG. 10A but with the spacer in a second position.

FIG. 10C is a cross-sectional view of the rocker of FIG. 10A.

FIG. 10D is a cross-sectional view of the rocker of FIG. 10B.

FIG. 10E is a top view of the rocker of FIG. 10A.

FIG. 10F is a top view of the rocker of FIG. 10B.

FIG. 10G is a side view of the rocker of FIG. 10A.

FIG. 10H is a side view of the rocker of FIG. 10B.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Measuring ingredients, dry and liquid, for cooking or other activities is an activity as old as the kitchen. However, having separate measurement devices for each container requires having many measuring devices, such as measuring cups and spoons, with their own inherent problems. The present invention relates to a solid or liquid measuring device designed to offer a more convenient and accurate means of measuring cooking ingredients. This device addresses several problems associated with the traditional measuring spoons and cups. Such problems include the time taken to locate and wash multiple measuring spoons, lack of accuracy in measuring, and the messiness associated with standard measuring devices.

The invention solves these problems by providing an all-in-one solution that eliminates the need for multiple measuring utensils, making it easier and more efficient to measure cooking ingredients. The device features a built-in pre-measured cap with a universal, flexible silicone thread design that fits onto a wide range of standard spice bottles, accommodating various bottle sizes.

This innovative design offers a hassle-free, mess-free, and accurate method of measuring ingredients, and eliminates the need for additional cleaning of utensils. The device would be mounted onto each dispensable product, reducing clean-up time, and allowing for direct pouring, making it a valuable addition to any kitchen.

The design is adaptable to different containers. This is achieved using universal silicone threads for wide adaptability. In some embodiments, the flexible threads may be dimples.

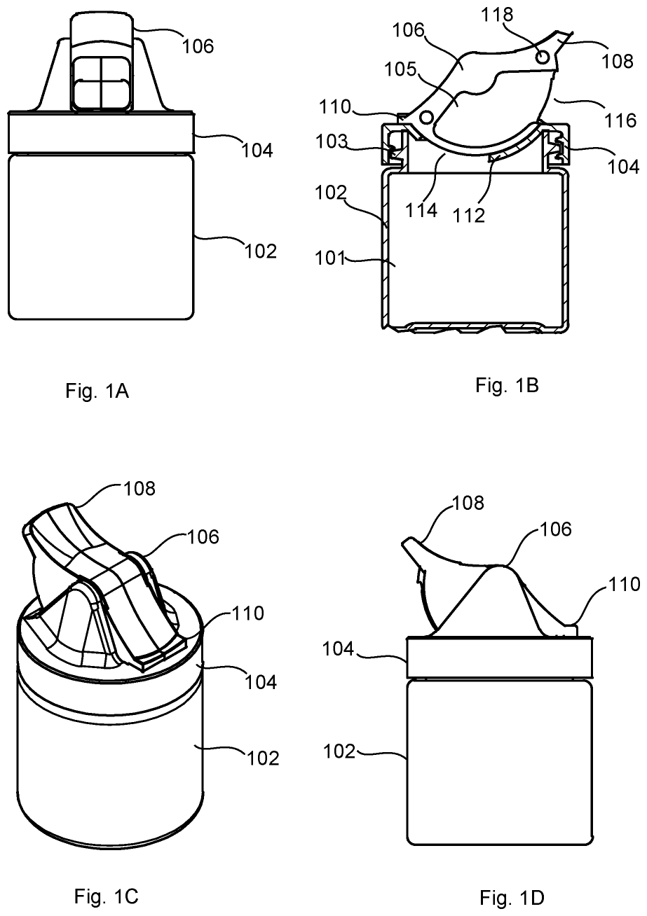

FIG. 1A is a front elevation view of a bottle and a cap with a rocker that may be used in one embodiment of the present invention. FIG. 1B is a cross-sectional view of the bottle and cap of FIG. 1A. FIG. 1C is an isometric view of the bottle and cap of FIG. 1A. FIG. 1D is a side elevation view of the bottle and cap of FIG. 1A. A bottle 102 with threads 103 contains an ingredient 101 inside the bottle. A dispensing cap 104 threads onto the bottle 102. The dispensing cap has a flap 112 that partially covers the space in the bottle 102, leaving an opening 114. This flap 112 may be termed a closure and prevents fluid communication when the rocker is moving to the external dispensing position. The dispensing cap 104 includes a rocker 106. The rocker 106 is a dispenser and has an opening end 110 and a closing end 108. When closing end 108 is pressed down by the user, the rocker section 105 gains fluid communication through 114 with the inside of the bottle 102. When the bottle 102 is inverted, spice 101 fills the rocker section 105. While still inverted, the user presses opening end 110 and causes opening 116 to form such that spice in rocker section 105 pours out of the system.

In this embodiment, dimples 118 make an audible or haptic click when the rocker reaches fully open or fully closed, giving feedback to the user that the rocker has traveled fully.

In this embodiment, the rocker 106 can be split into multiple rockers, each of which has a separate internal volume, allowing each rocker to give a different measurement. For example, the rocker 106 could be split in half, with one side having an internal volume of 1 teaspoon while the other half had a volume of ½ teaspoon.

The flexible silicon thread of the cap 104 is stretchable such that it can attach to a variety of diameters of bottles. Different caps can attach to different diameter ranges.

In some embodiments, the rocker section 105 has more than one space, such that the user can close the rocker by pressing 108 a certain distance and fills up only the spaces desired in the rocker section 105, allowing for a variety of measured volumes to be dispensed.

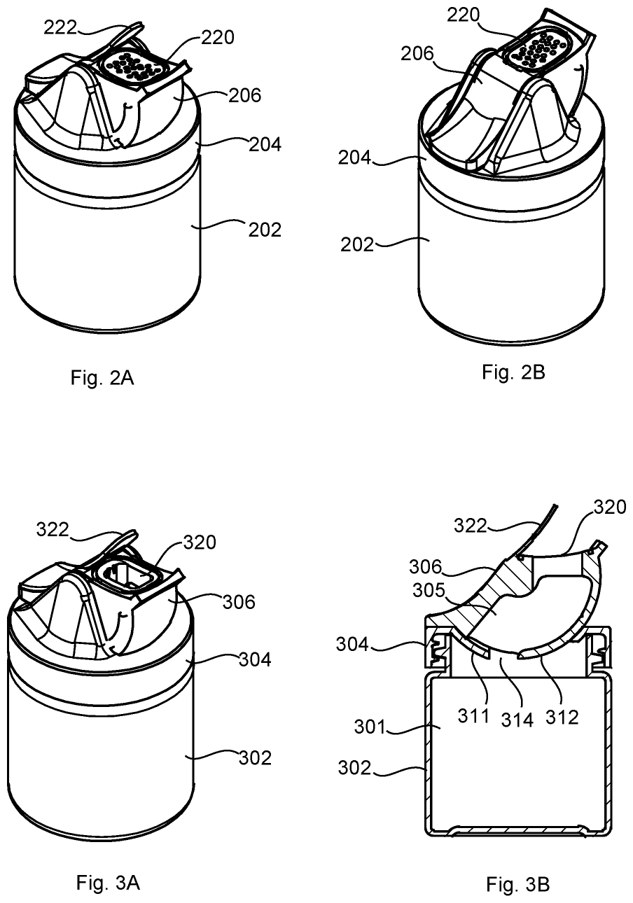

FIG. 2A is a front left isometric view of a bottle and a cap with a rocker that may be used in one embodiment of the present invention. FIG. 2B is a back right isometric view of the bottle and cap of FIG. 2A with the dispenser cap removed. The bottle 202, threaded cap 204, and rocker 206 are directly parallel to 102, 104, and 106 of FIGS. 1A-D. However, instead of an opening equivalent to 116, a sifter cap 220 covered by cover 222 is provided. When the bottle is inverted and the rocker section is filled with ingredient, cover 222 prevents outflow of the ingredient. The rocker is toggled and when the cap 222 is removed, the ingredient is sprinkled out through the sifter cap 220 by the user in whatever pattern desired by the user. This allows the user to distribute the measured volume evenly throughout the area rather than dumping it all in one spot.

FIG. 3A is a front left isometric view of a bottle and a cap with a rocker that may be used in one embodiment of the present invention. FIG. 3B is a cross-sectional view of the bottle and cap of FIG. 3A. The bottle 302, threaded cap 304, and rocker 306 are directly parallel to 102, 104, and 106 of FIGS. 1A-D. However, instead of an opening equivalent to 116, a pour spout 320 covered by cover 322 is provided. Further, the rocker has three positions. Fully open, fully closed, and in between. When the bottle is inverted and the rocker section is fully closed, the section 305 is filled with ingredient and cover 322 prevents outflow of the ingredient. When the rocker is toggled to fully open and the cap 322 is removed, the ingredient is poured out through the pour spout 320 by the user. When the rocker is in between, as in FIG. 3B, and the cap 322 is open, there is fluid communication through opening 314 and through pour spout 320 from ingredients 301 all the way to the exterior. If inverted, the ingredient can simply pour from the bottle 302 through the pour spout 320. In this way, the dispensing cap 306 acts as an ingredient measurer when desired and as a simple pour spout when desired.

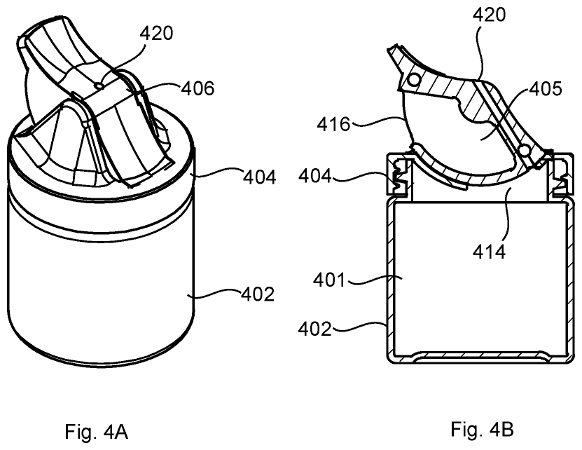

FIG. 4A is a back left cross-sectional view of a bottle and cap with a rocker that may be used in one embodiment of the present invention. FIG. 4B is a cross-sectional view of the bottle and cap of FIG. 4A. The bottle 402, threaded cap 404, and rocker 406 are equivalent to 102, 104, and 106 of FIGS. 1A-D. The rocker has three positions. Normally open, fully closed, and fully open. When the bottle is inverted and the rocker section is fully closed, the section 405 is filled with ingredient. When the rocker is toggled to normally open, the ingredient is poured out through the opening 416 by the user. When the rocker is fully open, as in FIG. 4B, there is fluid communication through pour spout 420 through opening 414 from ingredients 401 all the way to the exterior. If inverted, the ingredients can simply pour from the bottle 402 through the pour spout 420. In this way, the dispensing cap 406 acts as an ingredient measurer when desired and as a simple pour spout when desired.

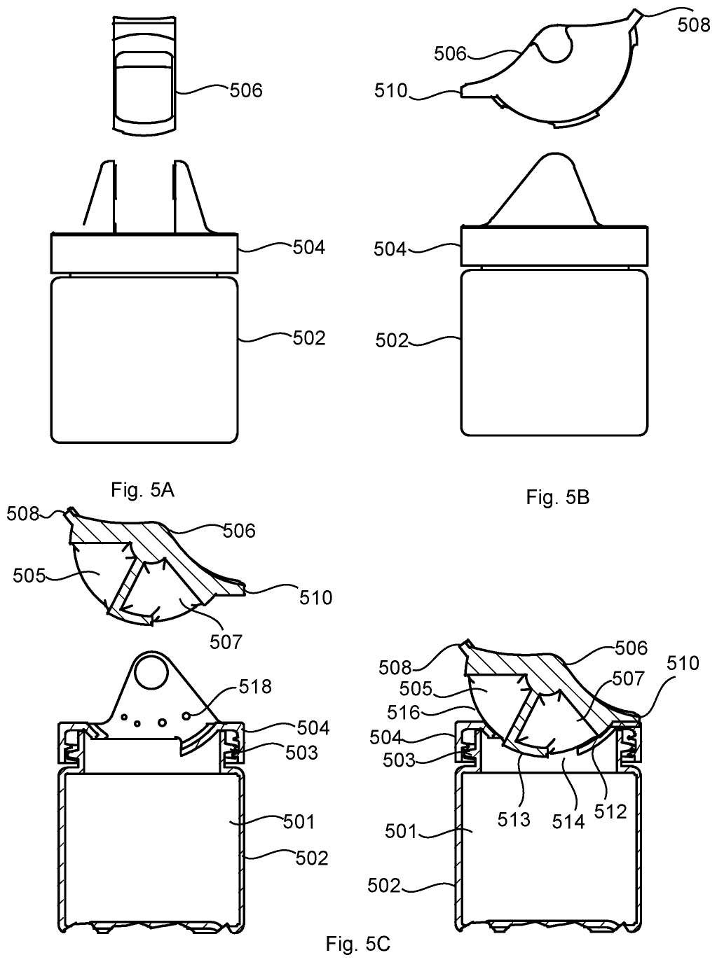

FIG. 5A is a front elevation view of a bottle and cap with rocker where the cap and rocker are in exploded view that may be used in one embodiment of the present invention. FIG. 5B is a side elevation view of the bottle and cap of FIG. 5A. FIG. 5C is a cross sectional view of the bottle and cap of FIG. 5A. A bottle 502 with threads 503 contains an ingredient 501 inside the bottle. A dispensing cap 504 threads onto the bottle 502. The dispensing cap has a flap 512 that partially covers the space in the bottle 502, leaving an opening 514. This flap 512 may be termed a closure and prevents fluid communication when a rocker 506 is moving to either external dispensing position. The dispensing cap 504 includes the rocker 506. The rocker 506 is a dual dispenser and has a larger opening end 510 and a smaller opening end 508. When smaller opening end 508 is pressed down by the user, the larger rocker section 505 gains fluid communication through 514 with the inside of the bottle 502. When the larger opening end 510 is pressed down by the user, the smaller rocker section 507 gains fluid communication through 514 with the inside of the bottle 502.

Starting from the bottle set on a counter with 510 pressed down, when the bottle 502 is inverted, spice 501 fills the small rocker section 507. While still inverted, the user presses opening end 508 which causes opening 516 to form such that spice in rocker section 507 pours out of the system.

Starting from the bottle set on a counter with 508 pressed down, when the bottle 502 is inverted, spice 501 fills the large rocker section 505. While still inverted, the user presses opening end 510 which causes opening 516 to form such that spice in rocker section 505 pours out of the system.

In one embodiment, rocker section 507 is ½ teaspoon while rocker section 505 is 1 teaspoon.

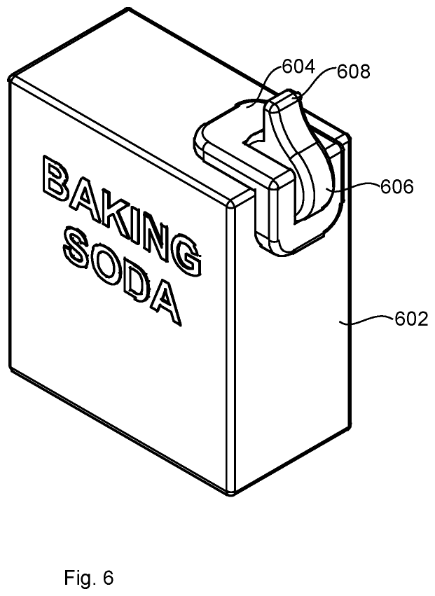

FIG. 6 is a front left isometric view of a box and cap with a rocker that may be used in one embodiment of the present invention. In this embodiment, the box 602 contains baking soda, but any ingredient may be in the box. The cap 604 may be inserted into the existing spout of the box 602 or a larger hole may be cut out of the box for the cap 604 to attach to the box 602. After this point, the rocker 606, which may be identical in the interior to that of FIGS. 1A-D, can be toggled by toggle 608 to allow the baking soda to enter a pre-measured volume inside the rocker 606 when the box 602 is inverted and then the pre-measured volume to be poured out when the rocker 606 is further toggled.

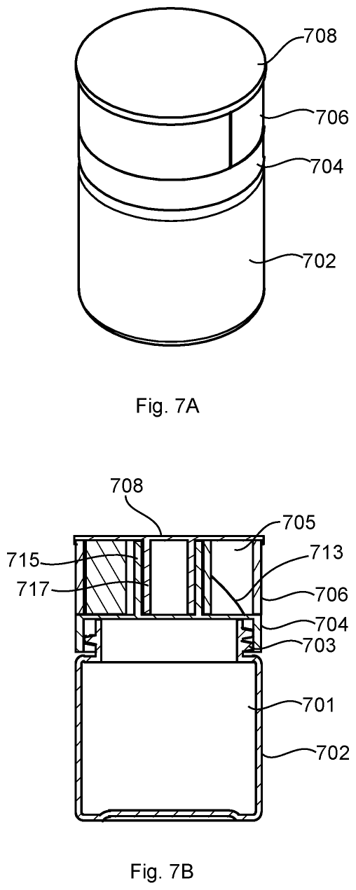

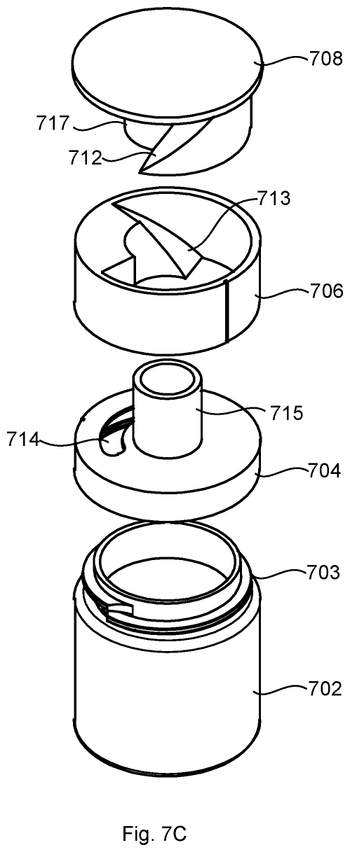

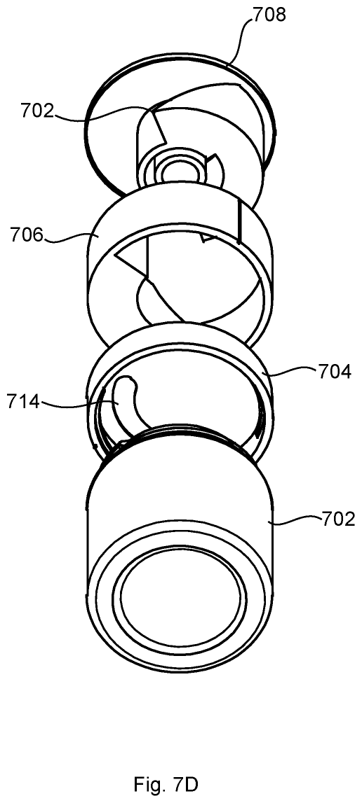

FIG. 7A is a front top isometric view of a bottle and cap that may be used in one embodiment of the present invention. FIG. 7B is a cross section of the bottle and cap of FIG. 7A. FIG. 7C is an exploded front top isometric view of the bottle and cap of FIG. 7A. FIG. 7D is an exploded front bottom isometric view of the bottle and cap of FIG. 7A. A user desires to measure and dispense an ingredient 701 from a bottle 702. A cap 704 has a flexible silicone thread that is configured to screw onto the threads 703 of the bottle 702. The cap 704 also has a rotatable filling section 706 attached to the cap 702. A cover 708 is also provided. The cap 704 has a slit 714 that allows fluid communication between the bottle 702 and the rotatable filling section 706 when spacer 713 of the rotatable filling section 706 is moved to uncover the slit 714. When spacer 713 rotates to cover the slit 714, cover 708 may be removed and ingredient 701 in volume 705 poured out. Cap 704 has a vertical guide 715 while cover 708 has a sheath 717 that attaches to guide 715. Cover 708 has a spacer 712 that prevents a portion of section 705 from filling with ingredient 701. When cover 708 is rotated, spacer 712 can increase or decrease the volume of section 705, increasing or decreasing the amount of ingredient 701 section 705 can accept. In one embodiment, cover 708 moves in discrete increments of desired measurement amounts, such as/4 teaspoon, ½ teaspoon, ¾ teaspoon, 1 teaspoon. This is one example and different embodiments would have appropriate measurement increments.

When the user attaches the cap 704 to bottle 702, the user will align rotatable filling section 706 such that slit 714 is in fluid communication with the bottle 702. The user will then align cover 708 such that a desired volume of section 705 is created. The user will invert the bottle and ingredient 701 will pour into section 705. The user then turns section 706 to cover slit 714 and can turn the bottle 702 back over. The user then removes cover 708 and pours the ingredient 701 where desired.

In one embodiment, the cover 708 may also have a pour spout with a cover that is opened when the user is ready to pour the ingredient.

The volume of the sections of the cap may be any measurement. In preferred embodiments, these volumes are common measurement values, such as teaspoons, tablespoons, cups, fractions of these, and other imperial measurements, for locations that use imperial measurements. For locations that use metric, the measurements may be any interval desired, such as milliliters, liters, and fractions of these.

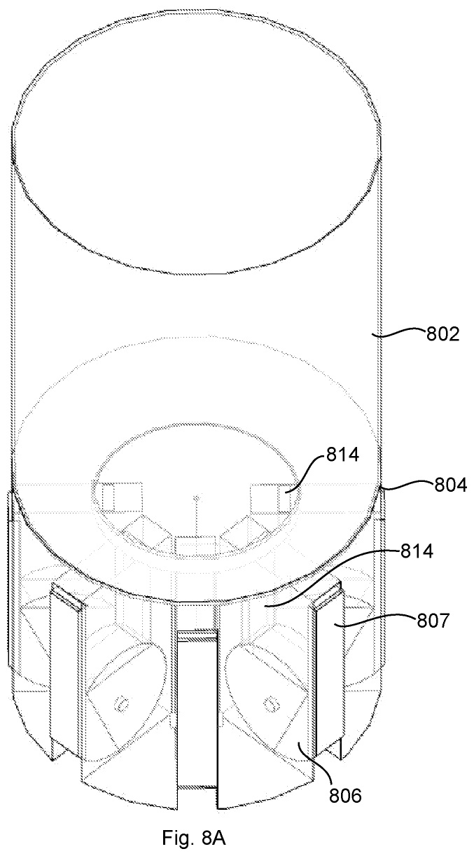

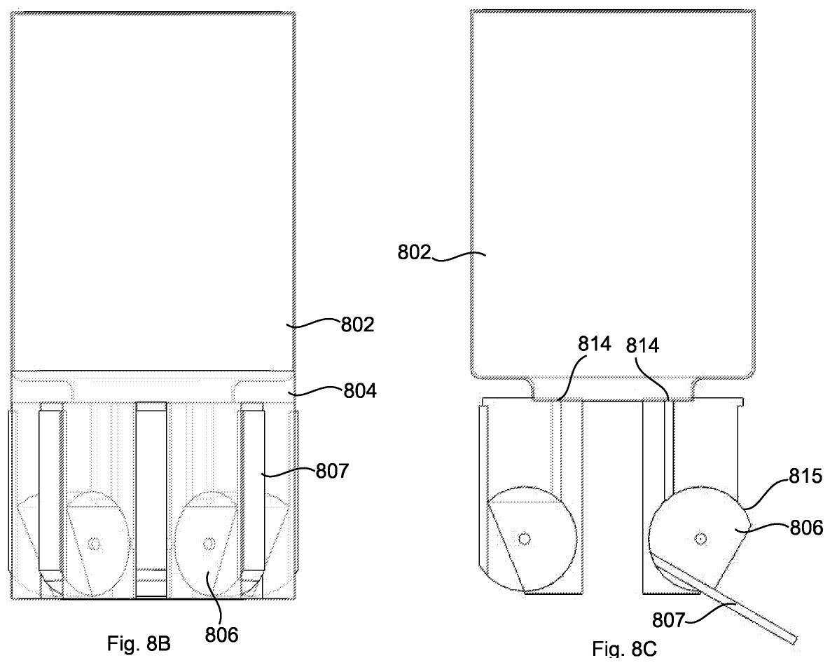

FIG. 8A is an isometric view of a bottle and dispenser that may be used in one embodiment of the present invention. FIG. 8B is an elevation view of the bottle and dispenser of FIG. 8A. FIG. 8C is an elevation view of the bottle and inside of the dispenser of FIG. 8A. An inverted bottle 802 of an ingredient has a dispensing cap 804 attached to the bottle 802. The dispensing cap 804 has eight dispensers 806 attached, each with an internal section of a known and different volume. When the spout 807 is in an upward position, ingredient pours through opening 814 into the dispenser. When the spout 807 is rotated downward by the user, wall 815 of the dispenser 806 blocks opening 814 and prevents further ingredient from coming into dispenser 814, and the ingredient pours out via spout 807 into the desired location.

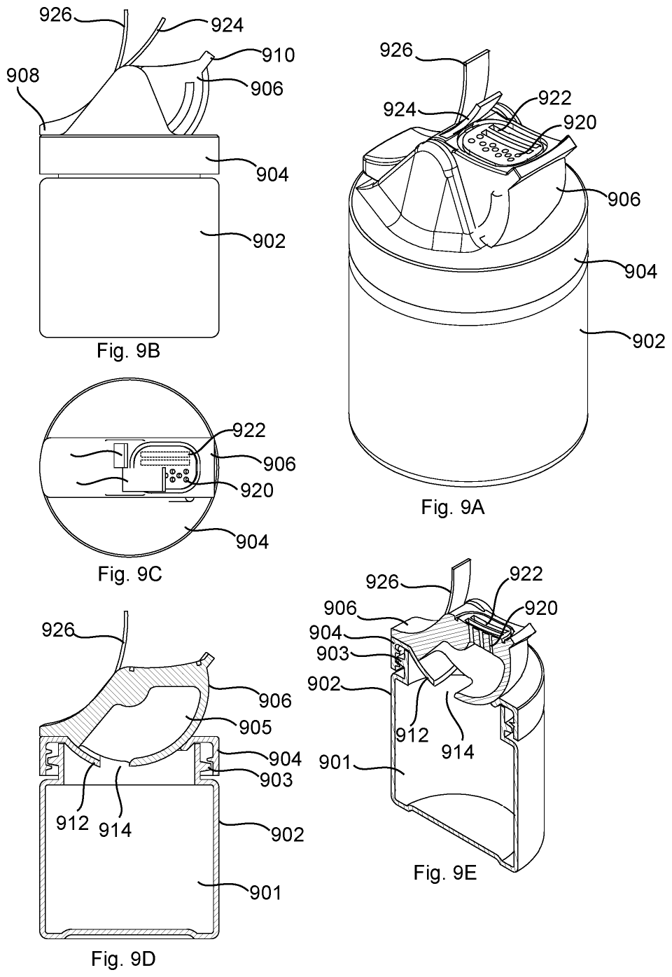

FIG. 9A is an isometric view of a bottle and dispenser that may be used in one embodiment of the present invention. FIG. 9B is a side view of the bottle and dispenser of FIG. 9A. FIG. 9C is a top view of the bottle and dispenser of FIG. 9A. FIG. 9D is a cross-sectional view of FIG. 9B. FIG. 9E is a cross-sectional view of FIG. 9A. A bottle 902 with threads 903 contains an ingredient 901 inside the bottle. A dispensing cap 904 threads onto the bottle 902. The dispensing cap has a flap 912 that partially covers the space in the bottle 902, leaving an opening 914. This flap 912 may be termed a closure and prevents fluid communication when the rocker is moving to the external dispensing position. The dispensing cap 904 includes a rocker 906. The rocker 906 is a dispenser and has an opening end 910 and a closing end 908. When closing end 908 is pressed down by the user, the rocker section 905 gains fluid communication through 914 with the inside of the bottle 902. When the bottle 902 is inverted, spice 101 fills the rocker section 905. While still inverted, the user presses opening end 910 and causes an opening to the outside to form such that spice in rocker section 905 pours out of the system.

In this embodiment, the rocker section 906 has a sifter 920 and slits 922 that are covered by cover 924 and cover 926, respectively. When the user desires to use the sifter 920 or the slits 922, the user opens the appropriate cover. When the user desires to pour directly from the bottle 902 to the exterior, the user keeps the rocker 906 in the closed position and opens one or both of the covers 924 or 926. With the covers closed, the space 905 becomes a measuring device to measure a known quantity of the ingredient 901, as in other embodiments.

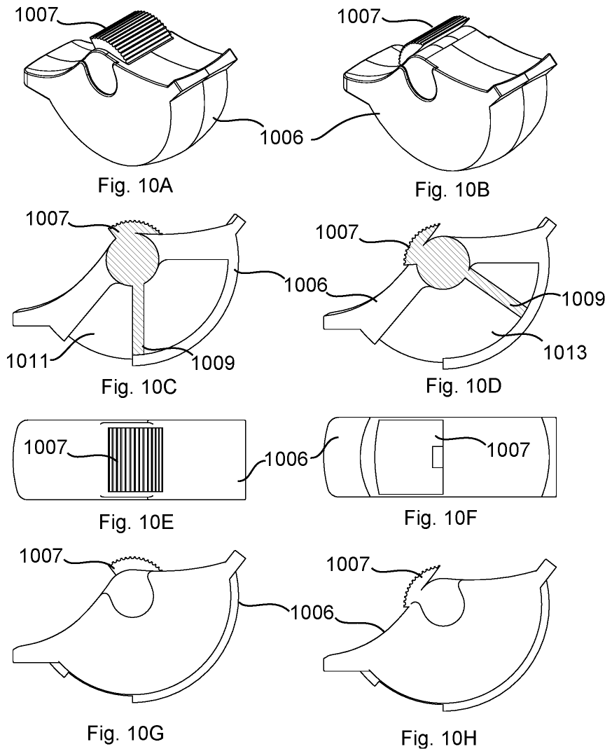

FIG. 10A is an isometric view of a rocker with a spacer in a first position that may be used in one embodiment of the present invention. FIG. 10B is an isometric view of the rocker of FIG. 10A but with the spacer in a second position. FIG. 10C is a cross-sectional view of the rocker of FIG. 10A. FIG. 10D is a cross-sectional view of the rocker of FIG. 10B. FIG. 10E is a top view of the rocker of FIG. 10A. FIG. 10F is a top view of the rocker of FIG. 10B. FIG. 10G is a side view of the rocker of FIG. 10A. FIG. 10H is a side view of the rocker of FIG. 10B. The rocker 1006 of these figures may be used in place of any of the rockers of previous figures. The rocker 1006 has a selection knob 1007 that moves a lever 1009. When the user fully closes 1009 by moving knob 1007, as in FIG. 10C, the resultant volume 1011 available for ingredient to fill is minimized. When the user fully opens 1009 by moving knob 1007, as in FIG. 10D, the resultant volume 1013 for ingredient to fill is maximized.

In one embodiment, the knob 1007 moves in discrete increments to produce volumes from fully closed 1011 to fully open 1013 with a variety of desired volume increments in between. These volumes may be printed on the rocker such that the user can select a desired volume. For example, the minimum volume 1011 may be ⅛ teaspoon and the maximum volume 1013 may be 1 teaspoon, with increments of ⅛ teaspoon between these limits.

In another embodiment, the knob 1007 moves in a continuous manner to produce the volumes from fully closed 1011 to fully open 1013. In this version, the volumes may be printed on the rocker 1006 and the user may move the knob 1007 to those increments or to increments between, allowing for more flexibility in the selection of volume of ingredient.

In some embodiments, a spring is employed between a rocker and the cap to achieve a retractable design. The spring functions to provide a constant force that ensures the rocker remains in the closed position. When pressed by a person's thumb, the spring allows the rocker to slide forward when pressure is applied. The rocker returns to its original position when the thumb or hand force is released by the action of the spring.

The invention has been described with reference to various specific and preferred embodiments and techniques. Nevertheless, it is understood that many variations and modifications may be made while remaining within the spirit and scope of the invention.

What is claimed is:

1. A system for measuring an ingredient comprising:
a dispensing cap comprising a flexible silicone thread configured to screw onto a threaded bottle;
the dispensing cap further comprising a first section of a known volume configured to receive the ingredient in the known volume from the threaded bottle when a user inverts the threaded bottle;
the dispensing cap further comprising a closure configured to prevent fluid communication between the section and the threaded bottle when the closure is engaged by the user; and
the dispensing cap further comprising a dispenser configured to provide fluid communication between the section and an outside space when the dispenser is engaged by the user and the dispenser further configured for a user to pour the ingredient out of the section into the outside space.

2. The invention of claim 1, the flexible silicon thread further configured to screw onto a range of diameters of threaded bottles.

3. The invention of claim 2, wherein the flexible silicon thread comprises discrete dimples rather than a contiguous thread.

4. The invention of claim 1, further comprising one or more further sections of other known volumes configured to receive the ingredient in the other known volumes.

5. The invention of claim 4, wherein the user selects a selected section from the first section or one of the one or more further sections, inverts the threaded bottle such that the ingredient passes into the selected section, the user engages the closure, the user engages the dispenser, and the user pours the ingredient out of the selected section.

6. The invention of claim 1, wherein the threaded bottle is a puncture device that pierces into a cardboard container containing the ingredient and provides a path for the ingredient to pass into the dispensing cap.

7. The invention of claim 1, wherein the dispensing cap comprises a rocker that comprises the closure and the dispenser, and wherein the user presses on a first end of the rocker such that the closure opens to allow fluid communication between the section and the threaded bottle, and wherein the user presses on a second end of the rocker such that the closure closes such that there is no fluid communication between the section and the threaded bottle, and wherein the user further presses on the second end of the rocker such that the dispenser opens and establishes fluid communication between the section and the outside space.

8. The invention of claim 7, wherein the rocker is segmented into the first section and one or more further sections and the rocker is configured to provide haptic feedback as the user presses the first end of the rocker to open fluid communication to the first section and further to each of the one or more further sections.

9. The invention of claim 8, wherein the first section and the one or more further sections are sized such that each of the first section and the one or more further sections are of a volume typical to use with the ingredient in the threaded bottle.

10. The invention of claim 8, wherein the rocker is further configured such that after the rocker is opened to a last of the one or more further sections, the user further presses the first end of the rocker and the closure and the dispenser align such that the threaded bottle and the outside space are in fluid communication and the user pours the ingredient directly from the threaded bottle into the outside space.

11. The invention of claim 7, further comprising a plurality of rockers, each of the plurality of rockers comprises a section comprising a different volume than other sections of the plurality of rockers.

12. A system for measuring an ingredient comprising:
a cap comprising a flexible silicone thread configured to screw onto a threaded bottle, a shaft, and a slit;
a rotatable filling section attached to the cap and configured to rotate to block the slit and prevent fluid communication between the threaded bottle and a dispensable volume or to expose the slit and allow fluid communication between the threaded bottle and the dispensable volume,
a volume selector inserted into the radial volume and rotatably attached to the shaft, wherein the volume selector rotates to be adjacent a first end of the portion of the radial space to provide a largest dispensable volume and the volume selector rotates to be adjacent a second end of the portion of the radial space to provide a smallest measurable volume, and wherein the dispensable volume is any volume between and including the largest dispensable volume and the smallest dispensable volume; and
a lid configured to cover the dispensable volume;
wherein a user rotates the rotatable filling section such that the threaded bottle is in fluid communication with the dispensable volume, the user further rotates the volume selector to a desired dispensable volume, and the user inverts the threaded bottle and cap such that the ingredient pours into the desired dispensable volume; and
wherein the user rotates the rotatable filling section such that the threaded bottle and the dispensable volume are not in fluid communication, and the user removes or rotates the lid to dispense the ingredient from the desired dispensable volume to an outside space.

13. The invention of claim 12, wherein the user further inverts the threaded bottle and cap before removing the lid such that the ingredient stays in the desired dispensable volume until the user dispenses the ingredient.

14. A system for measuring an ingredient comprising:
a dispensing cap configured to attach to an ingredient container;
the dispensing cap comprising a first section of a known volume configured to receive the ingredient in the known volume from the bottle;
the dispensing cap further comprising a closure configured to prevent fluid communication between the section and the ingredient container when the closure is engaged by the user; and
the dispensing cap further comprising a dispenser configured to provide fluid communication between the section and an outside space when the dispenser is engaged by the user and the dispenser further configured for a user to pour the ingredient out of the section into the outside space.

15. The invention of claim 14, the flexible silicon thread further configured to screw onto a range of diameters of threaded bottles.

16. The invention of claim 15, wherein the flexible silicon thread comprises discrete dimples rather than a contiguous thread.

17. The invention of claim 14, further comprising one or more further sections of other known volumes configured to receive the ingredient in the other known volumes.

18. The invention of claim 17, wherein the user selects a selected section from the first section or one of the one or more further sections, inverts the threaded bottle such that the ingredient passes into the selected section, the user engages the closure, the user engages the dispenser, and the user pours the ingredient out of the selected section.

19. The invention of claim 14, wherein a plurality of dispensers are attached to an ingredient container via a single dispensing cap.

20. The invention of claim 19, wherein the plurality of dispensers comprise a range of volumes.
